(19) United States
(12) Patent Application Publication
(10) Pub. No.: US 2011/0092636 A1
(43) Pub. Date: Apr. 21, 2011

(54) WATER SWELLABLE AND WATER SOLUBLE POLYMERS AND USE THEREOF

(76) Inventor: Anbanandam Parthiban, Singapore (SG)

(21) Appl. No.: 12/972,685

(22) Filed: Dec. 20, 2010

Related U.S. Application Data
(63) Continuation of application No. PCT/SG2008/000218, filed on Jun. 20, 2008.

(51) Int. Cl. C08F 22/40; C08F 222/40; C08L 79/08; C09D 179/08; C09J 179/08

(52) U.S. Cl. 524/548; 526/262

(57) ABSTRACT

The present invention provides a polymer comprising units according to formula III

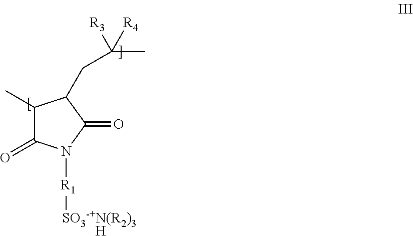

wherein
R₁ is selected from C₁ to C₁₀ alkylene and C₅ to C₂₀ arylene; each R₂ is selected independently from H and C₁ to C₁₀ alkyl; and R₃ and R₄ are selected independently from H and C₁ to C₃₀ alkyl. Embodiments of the invention provide polymers that are water soluble or water swellable and can form transparent and flexible films.

### REFERENCE TO RELATED APPLICATION

This application is a continuation of International Application No. PCT/SG2008/000218, filed Jun. 20, 2008, which is hereby incorporated by reference.

### FIELD OF THE INVENTION

The present invention is concerned with water swellable and water soluble polymers. In particular, water soluble polymers derived from poly(maleic anhydride) and their use in wall coatings and water based adhesives.

### BACKGROUND

Water soluble and water swelling polymers have many applications.

Water soluble polymers are useful for making elastic coatings as temporary coverings for various surfaces like glass, metal and plastic. They can protect against mechanical damage and environmental degradation during storage and transportation. Owing to their water soluble nature, dispersions free of solvents can be made in water and applied on these surfaces by spraying, rolling or dipping. The continuous film thus formed can be stripped off from the respective surface after storage and transportation.

Water soluble polymers also can induce flocculation and thickening properties. Hence they are useful in water purification in various industries. Water swelling polymers are useful for making water based gels which have applications in cosmetics and medicine.

Water soluble polymers are prepared by various methods. U.S. Pat. No. 7,230,061 discloses the preparation of (meth)acrylic acid based water soluble polymers with a high intrinsic viscosity. U.S. Pat. No. 7,214,737 discloses the preparation of aqueous polymer dispersion of acrylic or acrylic styrene with a high binding power towards fillers. U.S. RE39450 E discloses a water soluble polyvinyl pyridinium derivative useful as anti-dye transfer and colour protection agent. U.S. Pat. No. 7,008,618 discloses a water soluble polymeric composition suitable for absorbing UV radiation. U.S. Pat. No. 7,005,143 discloses water swelling poly(alkylene oxide) based polymer gels. U.S. Pat. No. 6,472,136 discloses a water soluble polymeric surfactant based on hydrolyzed maleic anhydride derived co-polymers.

The anionic water soluble polymers that are commonly employed are: Poly(acrylic acid), acrylic or methacrylic acid derivatives such as the alkali metal and ammonium salts, polystyrene suphonate, carboxymethyl cellulose, alginate salts etc. Polyethylene glycol is also water soluble.

Polymers which swell in water are also termed as hydrogels. Hydrogels are formed as a result of the absorption of water by super absorbent polymers which are in general water insoluble due to crosslinking. They are capable of absorbing large amounts of aqueous liquids and body fluids such as urine and blood. Because of these characteristic absorption properties these super absorbent polymers are mainly used in sanitary articles such as diapers, sanitary napkins, and in the cultivation of plants etc. The following U.S. patents describe the formation and uses of super absorbent polymers: U.S. Pat. No. 7,173,086, U.S. Pat. No. 7,163,969, U.S. Pat. No. 7,163,966, U.S. Pat. No. 6,087,450 and U.S. Pat. No. 6,087,450.

Commercially available super absorbent polymers are, mainly, crosslinked polyacrylic acids or crosslinked starch/acrylic acid graft co-polymers wherein the carboxyl groups are partially neutralized with sodium or potassium ions. Indeed, known water soluble polymers are generally prepared by neutralizing a polymer bearing carboxylic acids with alkali metals.

### SUMMARY AND DESCRIPTION OF PREFERRED EMBODIMENTS

The present inventors have noted that known water soluble polymers of the sort used to form temporary coverings are not able to form clear transparent coatings. For example, a hazing or “crazing” can occur.

At its broadest, the present invention proposes that cyclic imido sulfonic acid groups should be incorporated into a polymer to provide novel and useful water swellable or water soluble polymers. In particular, the present inventor has found that such useful water swellable or water soluble polymers can be made from poly(cyclic anhydride) by reaction with an amino sulfonic acid to form a polymer having repeating units comprising cyclic imido sulfonic acid.

Particularly useful examples of this include derivatives of poly(maleic anhydride), including copolymers of poly(maleic anhydride), which are formed by reaction of the poly(maleic anhydride) with alkyl or aryl amino sulfonic acids.

Furthermore, quaternary ammonium salts of such polymers, suitably formed by addition of a tertiary amine, demonstrate surprising advantages with respect to known water soluble or water swellable polymers.

In a first aspect, the present invention provides a polymer having repeating units comprising a cyclic imido sulfonic acid according to formula I

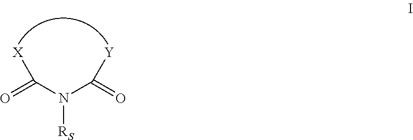

wherein X and Y are selected to form an optionally substituted cyclic imido; and R_{S} is a sulfonic acid-containing group or salt thereof.

Suitably X and Y are selected so that the cyclic imido is a pyrrolidine-2,5-dione.

These polymers show better solubility in water than polyvinyl alcohol and also the corresponding alkali metal salts obtained by the hydrolysis of poly(maleic anhydride).

The solutions prepared by dissolving the polymer of the present invention in water are clear, transparent and less viscous whereas the solutions obtained by dissolving polyvinyl alcohol and the metal salts obtained by the hydrolysis of poly(maleic anhydride) are turbid.

Aqueous solutions of the polymer of the present invention can be used to form clear, transparent, uniform coatings on substrates like glass. A free standing, flexible, transparent film can be obtained by casting a polymer solution of the present invention on a glass plate.

The polymer can be used as a component in a paint composition, where it can significantly reduce the contact angle of the coating with water, thereby aiding the waterproofness of the paint composition. This can also make it easier to clean the paint composition. This makes the polymer particularly suitable for use in exterior paint compositions.

The polymer is preferably a free radical addition polymer. As discussed in more detail below, the polymer can be a homopolymer or a copolymer.

Suitably the cyclic imido sulfonic acid is formed by the reaction of a cyclic anhydride with an amino sulfonic acid. The present inventor has found that a cyclic anhydride is particularly effective for forming the cyclic imido sulfonic acid in a simple one-step reaction. Suitably the reaction between the amine and the —O— moiety of the anhydride causes formation of the imido group. In preferred embodiments, the reaction proceeds as follows:

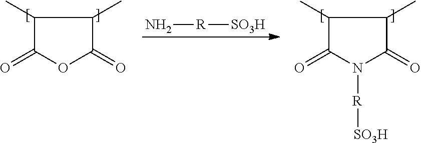

wherein R is a spacer, typically optionally substituted alkylene or arylene.

Suitably the cyclic anhydride precursor is present in the form of poly(cyclic anhydride). Thus, it is preferred that the starting material is a polymer. In particular, it is preferred that the formation of the cyclic imido sulfonic acid occurs by selective reaction of a cyclic anhydride repeating unit in the starting material polymer.

The cyclic anhydride can be any cyclic anhydride, provided it has an ethylenically unsaturated bond suitable for free radical polymerisation. In other words, the cyclic anhydride must be capable of polymerisation to form poly(cyclic anhydride). Preferred cyclic anhydrides include alicyclic or aromatic anhydrides.

In particularly preferred embodiments the cyclic anhydride is maleic anhydride. Thus, a preferred starting material is poly(maleic anhydride). The present invention is therefore concerned in preferred embodiments with a polymer comprising units derived from maleic anhydride. However, other cyclic anhydrides, and hence corresponding poly(cyclic anhydrides), can be used.

It follows that the polymer units comprising imido sulfonic acid formed from the poly(cyclic anhydride) will have a cyclic imido structure corresponding to the cyclic structure of the anhydride. For example, cyclic imido structures comprising succinimidyl or phthalimidyl are preferred.

The water soluble or water swellable properties of the polymer of the present invention are particularly surprising given that the preferred starting polymer of poly(maleic anhydride) is insoluble in water.

Furthermore, the film forming properties of the polymer of the present invention are also surprising given that the preferred starting material poly(maleic anhydride) forms a brittle, non-continuous film upon casting and is non-transparent. Similarly, the hydrolyzed product of the poly(maleic anhydride) when cast from aqueous solution on a glass plate results in an unsatisfactory film, being non-uniform, non-transparent and inhomogeneous.

Surprisingly, the present inventor has found that the advantageous properties of the polymer of the present invention can be obtained independently of the exact structure of the cyclic imido sulfonic acid. Thus, provided the polymer has repeating units comprising the cyclic imido sulfonic acid, the polymer will suitably exhibit at least some of the properties described herein.

The cyclic imido group may be important for its ability to introduce rigidity and hence planarity to the repeating units of the polymer.

The provision of a sulfonic acid or sulfonic acid salt-containing group as the imido substituent imparts the polymer with a strong interaction with water and also with nitrogen-containing organic. In particular, by providing an interaction that favours the inclusion of a tertiary amine base (examples of which are discussed below) an ionic interaction can be achieved between polymer chains. Indeed, long range interchain interaction is believed to assist in the formation of films, and is a desirable property of polymers of the present invention. In addition, the provision of these groups contributes to the excellent water solubility or water swellability of the polymer.

Furthermore, the ionic nature of the polymer leads to long range interaction between polymer chains. Due to this increased interaction, the chains can align together which assists in film formation.

Preferably the amino sulfonic acid is NH₂—R₁—SO₃H, wherein R₁ is selected from optionally substituted C₁ to C₁₀ alkylene and C₅ to C₂₀ arylene. The amino group reacts with the anhydride functionality to produce the desired imido group. The present inventor has found that this reaction can be used to reliably convert an anhydride to an imido even when the anhydride is part of a polymer.

Thus, a particular advantage of using an amino sulfonic acid is that the reaction to form the polymer can be carried out in a single step, i.e. a “one pot” reaction. Thus, starting from a poly(cyclic anhydride), the polymer can be formed in a single step, by addition of the amino sulfonic acid to the poly(cyclic anhydride).

Particularly preferred amino sulfonic acids are taurine (2-aminoethanesulfonic acid) and metanilic acid (3-aminobenzenesulfonic acid). Taurine is most preferred.

The present inventor has found that the polymer exhibits particularly useful properties, particularly in respect of film formation, when the sulfonic acid is present as a salt. Thus, R_{S} in formula I is suitably a sulfonic acid salt. Particularly preferred salts are quaternary ammonium salts and alkali metal salts. Quaternary ammonium salts produce the best results and are therefore most preferred. Its ambiphilic nature enables the polymer to be soluble or swellable in water whilst preferably also being soluble in organic solvents.

If alkali metal salts are used, monovalent counterions such as lithium and sodium are preferred. Divalent counterions such as calcium and magnesium can also be used, as can multivalent counterions but these are less preferred because they may lead to the formation of a crosslinked polymer. Nevertheless, divalent and multivalent counterions may be used where flocculation is desired.

Suitably, in addition to the units comprising imido sulfonic acid groups according to formula I, the polymer comprises units derived from at least one ethylenically unsaturated monomer. Thus, suitably, the polymer is a copolymer. It can be selected from periodic copolymers, random copolymers, statistical copolymers and block copolymers. An alternating copolymer is preferred.

The ethylenically unsaturated monomer(s) can be selected from any of the known types of free radical polymerisable monomers often used as comonomers. Indeed, by selecting an appropriate comonomer or comonomers it is possible to adjust the interaction of the polymer with water and thereby control the behaviour of the polymer when mixed with water. For example, the polymer could be adjusted by appropriate choice of comonomer(s) so that it dissolves readily in water, swells before dissolving or remains swollen without dissolving.

Particularly preferred ethylenically unsaturated monomers are alkenes (e.g. ethylene, propylene, octadecene), styrene, vinyl pyrrolidine, (meth)acrylate(s) (in particular, methyl methacrylate), isobutene, vinyl pyridine, acrylonitrile, vinyl chloride and acrylic acid. An additional benefit of these, and other ethylenically unsaturated monomers, is that they copolymerise readily with the preferred monomer maleic anhydride.

As used herein, the term “(meth)acrylate(s)” includes acrylate(s) and methacrylate(s), as is well known in the art. Similarly, the term “(meth)acrylic acid” includes acrylic acid and methacrylic acid, as is well known in the art.

The units derived from these comonomers are suitably present, as a % of total units of comonomer and units comprising cyclic imido sulfonic acid, in an amount of up to about 50%, preferably up to 40%, more preferably up to 30%.

Suitably the polymer consists essentially of units according to formulae I and units derived from at least one ethylenically unsaturated monomer.

Thus, preferably the polymer comprises

(1) 50 to 100% units according to formula II

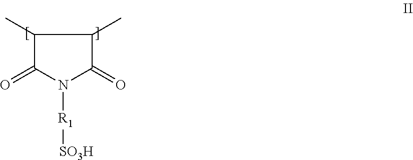

wherein R₁ is selected from optionally substituted C₁ to C₁₀ alkylene and C₅ to C₂₀ arylene, or a salt thereof; and
(2) 0 to 50% units derived from at least one ethylenically unsaturated monomer.

In this way, the properties of the polymer can be tuned, by incorporation of appropriate amounts of the ethylenically unsaturated monomer.

Whilst the above structure (and those given below) represent an alternating copolymer, the present invention also includes, as discussed above, other copolymer arrangements, such as periodic copolymers, random copolymers, statistical copolymers and block copolymers. For each of these other copolymers, the optional and preferred features described herein also apply.

In particularly preferred embodiments, the polymer comprises units according to formula III

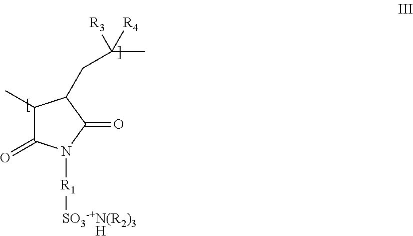

wherein
R₁ is selected from optionally substituted C₁₀ to C₁₀ alkylene and C₅ to C₂₀ arylene;
each R₂ is selected independently from H and optionally substituted C₁ to C₁₀ alkyl; and
R₃ and R₄ are selected independently from H and optionally substituted C₁ to C₃₀ alkyl, C₅ to C₂₀ aryl, pyrrolidinyl, carboxy and ester.

Preferably R₃ and R₄ are selected independently from H and optionally substituted C₁ to C₂₀ alkyl, more preferably from H and optionally substituted C₁₀ to C₂₀ alkyl, more preferably from H and optionally substituted C₁₅ to C₁₈ alkyl, and most preferably from H and optionally substituted C₁₅ to C₁₈ alkyl.

Preferably R₃ and R₄ are unsubstituted.

In particularly preferred embodiments, R₃ is H and R₄ is hexadecyl.

In other embodiments, R₃ and R₄ are selected independently from H and optionally substituted C₅ to C₂₀ aryl, preferably from H and optionally substituted phenyl.

In yet further embodiments, R₃ and R₄ are selected independently from H and optionally substituted carboxy and ester, preferably ester, wherein the ester is preferably —C(═O)OCH₃.

Suitably R₁ is selected from optionally substituted C₁ to C₆ alkylene and C₅ to C₁₅ arylene, preferably from optionally substituted C₁ to C₄ alkylene and C₅ to C₁₀ arylene, and more preferably from optionally substituted C₂ to C₄ alkylene and C₅ to C₈ arylene.

Suitably R₂ is unsubstituted.

In particularly preferred embodiments, R₁ is selected from ethylene and phenylene.

Suitably each R₂ is selected independently from H and optionally substituted C₁ to C₁₀ alkyl, preferably from H and optionally substituted C₁ to C₆ alkyl, more preferably from H and optionally substituted C₁ to C₃ alkyl.

Suitably R₂ is unsubstituted.

In particularly preferred embodiments, each R₂ is selected independently from H and ethyl. Even more preferably, each R₂ is ethyl.

In particularly preferred embodiments, the polymer has a structure according to formula IIIa

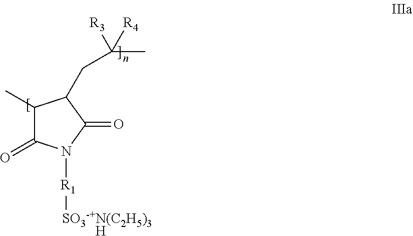

wherein each of R₁, R₃ and R₄ are as discussed above.

The present inventor has found that the properties of the polymer can be further enhanced and/or controlled if, in addition to the units comprising cyclic imido sulfonic acid, the polymer includes units comprising cyclic imido having a pendant group bonded to the imido nitrogen, wherein the pendant group is other than a sulfonic acid. Preferably the pendant group is a neutral species (non-ionic), preferably an optionally substituted alkyl or aryl.

Suitably the pendant group is formed by reacting a grafting component with the cyclic anhydride units of the poly(cyclic anhydride) precursor. More specifically, those cyclic anhydride units that are not reacted, e.g. with amino sulfonic acid, so as to form sulfonic acid-containing groups (R_{S} above) can then be reacted with an appropriate grafting component. Suitable grafting components comprise a primary amine group to facilitate reaction with the anhydride.

Indeed, the polymer demonstrates considerable flexibility in terms of its solubility or extent of swelling in water. These properties can be modified to adjust the polymer from water soluble to water swelling by changing the grafting components, and hence pendant groups on the imido units. This is surprising because conventionally water solubility and swellability can only be adjusted significantly by subjecting a water soluble polymer to undergo crosslinking.

The grafting component can be selected so as to provide a pendant group selected from alkyl, hydroxyl substituted alkyl or amine substituted alkyl. However, the grafting component can also be an aliphatic or aromatic amino acid.

Thus, in addition to units according to formula III, the polymer preferably also comprises units according to formula IV

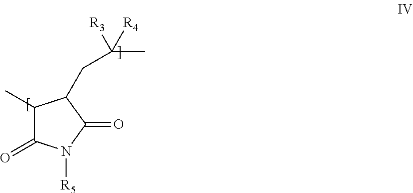

wherein R₅ is selected from optionally substituted C₁ to C₁₀ alkyl and C₅ to C₂₀ aryl; and
R₃ and R₄ are as defined above.

Preferably R₅ is selected from optionally substituted C₂ to C₈ alkyl, more preferably selected from amine and hydroxyl substituted C₂ to C₈ alkyl.

Suitably R₅ is optionally substituted C₆ alkyl. Preferably it is selected from hexyl and hexamethylamine.

It is also preferred that R₅ is optionally substituted C₂ alkyl, preferably ethylalcohol.

It is particularly preferred that R₅ is selected from hexyl, hexamethylamine and ethylalcohol.

Suitably the polymer consists essentially of units according to formulae III and IV.

Suitably the polymer includes more than one type of pendant group, such that there are two or more types of repeating units that comprise the reaction product of a cyclic anhydride and a grafting component. In this way, further control of the polymer's properties can be achieved.

Accordingly, it is preferred that the polymer comprises units according to formulae III, IV and V

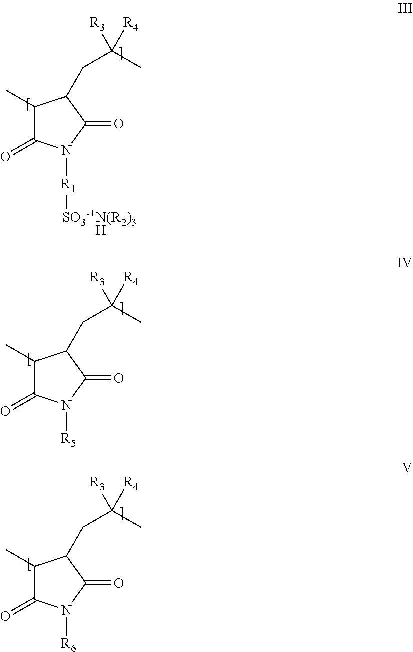

wherein
R₁ is as defined above;
each R₃ and R₄ is independently as defined above; and
R₅ and R₆ are selected independently from the definitions of R₅ given above.

Suitably R₅ and R₆ are different.

It is preferred that the units according to formula III are present, as a % of all of the units, in an amount of at least 50%. Thus, suitably, the ratio of units of formula III to the total number of units of formulae IV and V is at least 1. Preferably the ratio is at least 5, more preferably at least 10. Suitably the polymer consists essentially of units according to formulae III, IV and V.

The present inventor has found that the water swellable properties of the polymer can be further controlled by introducing crosslinking into the polymer. For example, this can be achieved by providing a pendant group on some of the cyclic imido units, which pendant group carries a group capable of reacting with a cyclic anhydride group on another part of the polymer. An example of such a group is a primary amine. Thus, a suitable pendant group would be an alkyl amine. Indeed, as noted above, one of the preferred R₅ and R₆ substitutents is hexamethylamine, which can be provided by the grafting component hexamethylenediamine, by reaction with a cyclic anhydride.

Thus, suitably the polymer is crosslinked.

Preferably the polymer comprises crosslinking groups according to formula VI

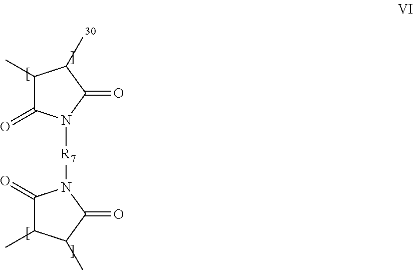

wherein R₇ is selected from optionally substituted C₁ to C₁₀ alkylene and C₅ to C₂₀ arylene. Optionally substituted C₁ to C₁₀ alkylene is preferred, with optionally substituted C₃ to C₈ alkylene and particularly C₆ alkylene being especially preferred.

Whilst an appropriate degree of crosslinking can be selected in order to provide the polymer with a desired level of water swellability, it is preferred that the degree of crosslinking, being the % of units that are crosslinked, is no more than 50%. In particular, the degree of crosslinking has been found to help control the mechanical stability of the swollen polymer. With this in mind, the skilled reader will be able to select an appropriate degree of crosslinking based on the application.

Suitably the molecular weight of the polymer (as measured by gel permeation chromatography with polystyrene standards) is in the range of 1000 to 1,000,000, preferably in the range of 5000 to 500,000, and more preferably in the range of 10,000 to 100,000.

Suitably the polymer is resistant to weight loss below 300° C. Weight loss measurements are made in the conventional way by thermogravimetric analysis (TGA) under a nitrogen atmosphere with a heating rate of 10° C./min.

Preferably the polymer exhibits a weight loss at 300° C. of no more than 10 wt %, preferably no more than 8 wt % and most preferably no more than 6 wt %.

Preferably the polymer exhibits a weight loss at 336° C. of no more than 20 wt %, preferably no more than 15 wt % and most preferably no more than 12 wt %.

Preferably the polymer exhibits a weight loss at 358° C. of no more than 30 wt %, preferably no more than 25 wt % and most preferably no more than 22 wt %.

Preferably the polymer is water swellable. The % swelling in water is calculated as follows:

swelling={([Weight of swollen polymer−weight of dry polymer]/weight of dry polymer)×100}

The measurement is made with deionised water and the polymer is allowed to reach equilibrium swelling

Preferably the polymer exhibits a % swelling in water of at least 100%, more preferably at least 200% and most preferably at least 300%

Suitably, the polymer exhibits reversible swelling. Preferably after five cycles of swelling and drying at least 80% of the % swelling observed in the first cycle is achieved, preferably at least 90%, and more preferably at least 95%. Suitably, reversible swelling is achieved after 10 cycles of swelling and drying. Drying is carried out at 80° C. for 24 hours.

Preferably the polymer is water soluble.

In a further aspect, the present invention provides a method of forming a polymer comprising the step of:
(1) reacting a poly(cyclic anhydride) with an amino sulfonic acid to form poly(imido sulfonic acid).

Suitably the poly(cyclic anhydride) is a co-polymer comprising units derived from (i) maleic anhydride and (ii) at least one ethylenically unsaturated monomer. Suitably it is an alternating copolymer.

Preferably the co-polymer is selected from poly(maleic anhydride-alt-octadecene), poly(maleic anhydride-alt-α-olefin), poly(maleic anhydride-alt-1-tetradecene) and poly(maleic anhydride-alt-isobutene).

Suitably the amino sulfonic acid in step (1) is used in a sub-stoichiometric amount such that not all of the cyclic anhydride is converted to an imido sulfonic acid in step (1), and the method includes the step of (2) reacting the poly(cyclic anhydride) with a primary amine.

Preferably steps (1) and (2) occur simultaneously.

Preferably the method includes the further step of adding a tertiary amine to the reaction product of step (1) or step (2) to form a quaternary ammonium salt.

Preferably tertiary amine is added at the start of, or shortly after, step (1). In other words it is preferred that the poly(cyclic anhydride), amino sulfonic acid and tertiary amine are reacted together simultaneously.

Suitably the reaction temperature of step (1) is in the range of room temperature to 200° C., preferably in the range 60° to 180° C. The duration of heating is preferably at least 15 hours, more preferably about 18 hours.

Preferably the reaction occurs in a dipolar aprotic solvent. It is also preferred that the reaction occurs in a high boiling point polar solvent. Suitably the boiling point of the solvent is higher than that of water. Preferably it is at least 110° C.]

Preferably the solvent is selected from N,N-dimethyl formamide, N,N-dimethyl acetamide and N-methylpyrrolidone. N,N-dimethyl formamide is most preferred.

In preferred embodiments the reaction (e.g. the reaction between the polymeric anhydride and the aminosulfonic acid in the presence of triamine) is carried out in the absence of solvent. Thus, a further advantage of the invention is the possibility of solvent-free reaction conditions.

In a particularly preferred embodiment of the present invention, the polymer is prepared according to Scheme 1:

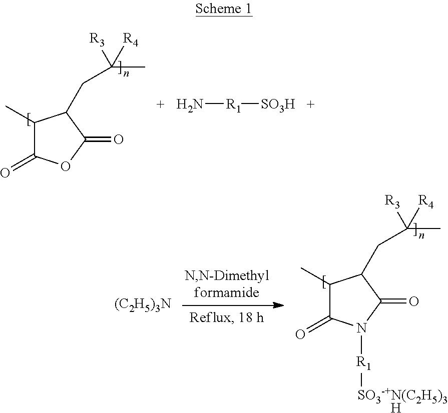

wherein each of R₁, R₃ and R₄ are as defined above.

This represents an efficient “one pot” synthesis of a quaternary ammonium salt of an imido sulfonic acid group-containing polymer.

As noted above, the most preferred amino sulfonic acids are taurine and metanilic acid and so R₁ is preferably ethylene or phenylene.

In a further aspect, the present invention provides a polymer formed by the method of the previous aspect.

In a further aspect, the present invention provides a latex comprising a polymer according to the present invention.

In a further aspect, the present invention provides a paint composition comprising a polymer according to the present invention.

Preferably the paint composition has a contact angle of less than 75°, more preferably less than 70° and most preferably less than 67°. The contact angle is measured with water by a static method using a goniometer. The measurement was made by providing the aqueous coating samples with the additive and without the additive and spreading them evenly on a microscopic glass slide and allowing to dry under ambient conditions. A drop of water was placed on the coated surface with the help of a syringe and viewed through a goniometer. The angle generated was measured by the goniometer controlled by a computer. Thus, the polymer of the present invention can be used as a contact angle lowering additive. By lowering the contact angle, the polymer makes the paint composition more hydrophilic, which results in better surface wettability and ease of cleaning.

In a further aspect, the present invention provides an adhesive comprising a polymer according to the present invention.

In a further aspect, the present invention provides a surfactant composition comprising a polymer according to the present invention.

Suitably the surfactant is a liquid. However, it can also be a solid.

In a further aspect, the present invention provides a method of making a polymer latex, the method comprising the step of dispersing the polymer of the present invention in water.

In a further aspect, the present invention provides a method of preparing a paint composition, the method comprising the step of mixing the polymer of the present invention with water.

Suitably the method includes the step of adding a pigment.

In a further aspect, the present invention provides a method of preparing an adhesive, the method comprising the step of adding the polymer of the present invention to water.

In a further aspect, the present invention provides a method of preparing a surfactant composition, the method comprising the step of adding a polymer of the present invention to the composition.

In a further aspect, the present invention provides use of a polymer according to the present invention in a latex.

In a further aspect, the present invention provides use of a polymer according to the present invention in a paint composition.

In a further aspect, the present invention provides use of a polymer according to the present invention in a surfactant composition.

### Chemical Terms

Alkylene: The term “alkylene,” as used herein, pertains to a bidentate moiety obtained by removing two hydrogen atoms, either both from the same carbon atom, or one from each of two different carbon atoms, of a hydrocarbon compound having from 1 to 20 carbon atoms (unless otherwise specified), which may be aliphatic or alicyclic, and which may be saturated, partially unsaturated, or fully unsaturated. Thus, the term “alkylene” includes the sub-classes alkenylene, alkynylene, cycloalkylene, etc., discussed below.

Examples of linear saturated C₁ to C₇ alkylene groups include, but are not limited to, —(CH₂)ₙ— where n is an integer from 1 to 7, for example, —CH₂— (methylene), —CH₂CH₂— (ethylene), —CH₂CH₂CH₂— (propylene), and —CH₂CH₂CH₂CH₂— (butylene).

Examples of branched saturated C₁₋₇alkylene groups include, but are not limited to, —CH(CH₃)—, —CH(CH₃)CH₂—, —CH(CH₃)CH₂CH₂—, —CH(CH₃)CH₂CH₂CH₂—, —CH₂CH(CH₃)CH₂—, —CH₂CH(CH₃)CH₂CH₂—, —CH(CH₂CH₃)—, —CH(CH₂CH₃)CH₂—, and —CH₂CH(CH₂CH₃)CH₂—.

Examples of linear partially unsaturated C₁ to C₇alkylene groups include, but is not limited to, —CH═CH— (vinylene), —CH═CH—CH₂—, —CH₂—CH═CH₂—, —CH═CH—CH₂—CH₂—, —CH═CH—CH₂—CH₂—CH₂—, —CH═CH—CH═CH—, —CH═CH—CH═CH—CH₂—, —CH═CH—CH═CH—CH₂—CH₂—, —CH═CH—CH₂—CH═CH—, and —CH═CH—CH₂—CH₂—CH═CH—.

Examples of branched partially unsaturated C₁ to C₇alkylene groups include, but is not limited to, —C(CH₃)═CH—, —C(CH₃)═CH—CH₂—, and —CH═CH—CH(CH₃)—.

Examples of alicyclic saturated C₁ to C₇alkylene groups include, but are not limited to, cyclopentylene (e.g., cyclopent-1,3-ylene), and cyclohexylene (e.g., cyclohex-1,4-ylene).

Examples of alicyclic partially unsaturated C₁ to C₇alkylene groups include, but are not limited to, cyclopentenylene (e.g., 4-cyclopenten-1,3-ylene), cyclohexenylene (e.g., 2-cyclohexen-1,4-ylene; 3-cyclohexen-1,2-ylene; 2,5-cyclohexadien-1,4-ylene).

Arylene: The term “arylene,” as used herein, pertains to a bidentate moiety obtained by removing two hydrogen atoms, one from each of two different aromatic ring atoms of an aromatic compound, which moiety has from 3 to 20 ring atoms (unless otherwise specified). Preferably, each ring has from 5 to 7 ring atoms.

The ring atoms may be all carbon atoms, as in “carboarylene groups” (e.g., C₅ to C₂₀ carboarylene).

Examples of C₅ to C₂₀ arylene groups which do not have ring heteroatoms (i.e., C₅ to C₂₀ carboarylene groups) include, but are not limited to, those derived from the compounds discussed above in regard to carboaryl groups.

Alternatively, the ring atoms may include one or more heteroatoms, as in “heteroarylene groups” (e.g., C₅ to C₂₀ heteroarylene).

Examples of C₅ to C₂₀ heteroarylene groups include, but are not limited to, those derived from the compounds discussed above in regard to heteroaryl groups.

Arylene-alkylene: The term “arylene-alkylene,” as used herein, pertains to a bidentate moiety comprising an arylene moiety, -Arylene-, linked to an alkylene moiety, -Alkylene-, that is, -Arylene-Alkylene-.

Examples of arylene-alkylene groups include, e.g., C₅ to C₂₀ arylene-C₁ to C₇ alkylene, such as, for example, phenylene-methylene, phenylene-ethylene, phenylene-propylene, and phenylene-ethenylene (also known as phenylene-vinylene).

Alkylene-arylene: The term “alkylene-arylene,” as used herein, pertains to a bidentate moiety comprising an alkylene moiety, -Alkylene-, linked to an arylene moiety, -Arylene-, that is, -Alkylene-Arylene-.

Examples of alkylene-arylene groups include, e.g., C₅ to C₂₀ alkylene-C₁ to C₇ arylene, such as, for example, methylene-phenylene, ethylene-phenylene, propylene-phenylene, and ethenylene-phenylene (also known as vinylene-phenylene).

Carboxy (carboxylic acid): —C(═O)OH.

Ester (carboxylate, carboxylic acid ester, oxycarbonyl): —C(═O)OR, wherein R is an ester substituent, for example, a C₁₋₇alkyl group, a C₃₋₂₀heterocyclyl group, or a C₅₋₂₀aryl group, preferably a C₁₋₇alkyl group. Examples of ester groups include, but are not limited to, —C(═O)OCH₃, —C(═O)OCH₂CH₃, —C(═O)OC(CH₃)₃, and —C(═O)OPh.

Amino sulfonic acid: a molecule comprising both amine and sulfonic acid. Examples include N(R)₂—R₁—SO₃H wherein each R is H, an alkyl or an aryl, and R₁ is alkylene or arylene.

Sulfonic acid: —S(═O)₂—OH

The term “Cyclic” as used herein, pertains to a group which has at least one ring.

Where a cyclic compound has two or more rings, they may be fused (e.g., as in naphthalene, decalin, etc.), bridged (e.g., as in norbornane, adamantane, etc.), spiro (e.g., as in spiro[3.3]heptane), or a combination thereof. Cyclic groups with one ring may be referred to as “monocyclic” or “mononuclear,” whereas cyclic groups with two or more rings may be referred to as “polycyclic” or “polynuclear.”

The term “unsaturated,” as used herein, pertains to compounds and/or groups which have at least one carbon-carbon double bond or carbon-carbon triple bond. Compounds and/or groups may be partially unsaturated or fully unsaturated.

### Substituents

The phrase “optionally substituted,” as used herein, pertains to a group which may be unsubstituted or which may be substituted.

Unless otherwise specified, the term “substituted,” as used herein, pertains to a group which bears one or more substitutents. The term “substituent” is used herein in the conventional sense and refers to a chemical moiety which is covalently attached to, or if appropriate, fused to, a parent group. A wide variety of substituents are well known, and methods for their formation and introduction into a variety of parent groups are also well known.

Examples of substituents include those listed above under the heading “definitions”. Typical substituents are:

### —F, —Cl, —Br, and —I;

### —OH;

### —OMe, —OEt, —O(tBu), and —OCH₂Ph;

### —SH;

### —SMe, —SEt, —S(tBu), and —SCH₂Ph;

### —C(═O)H;

### —C(═O)Me, —C(═O)Et, —C(═O)(tBu), and —C(═O)Ph;

### —C(═O)OH;

### —C(═O)OMe, —C(═O)OEt, and —C(═O)O(tBu);

### —C(═O)NH₂, —C(═O)NHMe, —C(═O)NMe₂, and —C(═O)NHEt;

—NHC(═O)Me, —NHC(═O)Et, —NHC(═O)Ph, succinimidyl, and maleimidyl;

### —NH₂, —NHMe, —NHEt, —NH(iPr), —NH(nPr), —NMe₂, —NEt₂, —N(iPr)₂, —N(nPr)₂, —N(nBu)₂, and —N(tBu)₂;

### —CN;

### —NO₂;

-Me, -Et, -nPr, -iPr, -nBu, -tBu;
—CF₃, —CHF₂, —CH₂F, —CCl₃, —CBr₃, —CH₂CH₂F, —CH₂CHF₂, and —CH₂CF₃;
—OCF₃, —OCHF₂, —OCH₂F, —OCCl₃, —OCBr₃, —OCH₂CH₂F, —OCH₂CHF₂, and —OCH₂CF₃;

### —CH₂OH, —CH₂CH₂OH, and —CH(OH)CH₂OH;

### —CH₂NH₂, —CH₂CH₂NH₂, and —CH₂CH₂NMe₂; and

phenyl.

Any one or more of the aspects of the present invention may be combined with any one or more of the other aspects of the present invention. Similarly, any one or more of the features and optional features of any of the aspects may be applied to any one of the other aspects. Thus, the discussion herein of optional and preferred features may apply to some or all of the aspects. In particular, optional and preferred features relating to the nature of the polymer apply to all of the aspects. Furthermore, optional and preferred features associated with a method or use may also apply to a product, and vice versa.

### BRIEF DESCRIPTION OF THE DRAWINGS

FIG. 1 shows the IR spectrum of the polymer of Example 1;

FIG. 2 shows the TGA curve of the polymer of Example 1; and

FIG. 3 shows the swelling curve of the polymer of Example 1

### EXAMPLES

### Example 1

### Preparation of Quaternary Ammonium Salt of Sulfonic Acid Group Containing Polymer

To an oven dried single neck round bottom flask, poly(maleic anhydride-alt-octadecene) (10 g), and taurine (3.57 g) were added. These two solids were stirred slowly using a magnetic stirrer. Dry N,N-dimethylformamide (DMF) (100 mL) was added through a syringe and the stirrer speed was increased. Triethylamine (2.89 g, 4 mL) was then added. The suspension turned light brown immediately after the addition of tertiary amine. The flask was then fitted with a double surface condenser and a drying tube on top of the condenser. This reaction mixture was heated in an oil bath at 160° C. for 18 h.

The reaction flask was then cooled and the DMF solution was added dropwise to a beaker containing a large excess of ethyl acetate and stirred well. The solid separated was allowed to settle. The ethylacetate layer was decanted off and the solid residue was washed repeatedly with ethyl acetate. Then the beaker was air dried to constant weight.

Yield 13 g. Gel Permeation Chromatography (Polystyrene standard; THF eluent): Mn=10563; Mw=16924; Polydispersity=1.60.

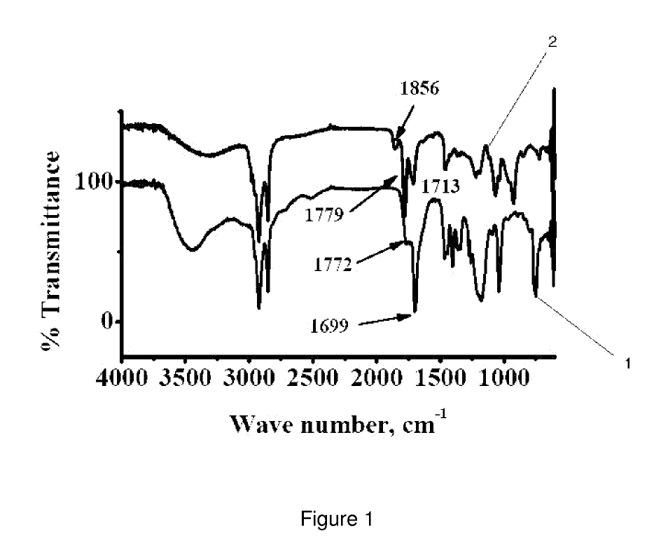

IR (KBr) cm⁻¹: 3449, 2924, 2853, 2759, 2739, 2679, 2492, 1772, 1699, 1468, 1447, 1405, 1365, 1348, 1192, 1044, 737, 668. The IR spectrum (1) is shown in FIG. 1. Spectrum (2) is that of the starting material, viz. poly(maleic anhydride-alt-octadecene). The labelled peaks for spectrum (2) are the asymmetric and symmetric stretching of anhydride carbonyls, 1856 and 1779 cm⁻¹ respectively. In spectrum (1), the labelled peaks are due to the asymmetric and symmetric stretching of imide carbonyls, 1772 and 1699 cm⁻¹ respectively.

¹H-NMR (CDCl₃) δ(ppm): 0.8-0.9 (t), 1.1-1.3 (b), 1.3-1.4 (t), 2.7-2.8 (b), 3-3.1 (b), 3.13.3 (b), 3.6-3.8 (b), 9.5-9.8 (b). ¹³C-NMR (CDCl₃) δ(ppm): 8.75, 14.1, 22.5, 27.77, 29.37, 29.76, 31.92, 34.73, 35.42, 38.75, 47.43, 49.38, 50.1, 179.1.

The observed ¹³C-NMR values correlated well with theoretical values calculated using ChemDraw® for the structure

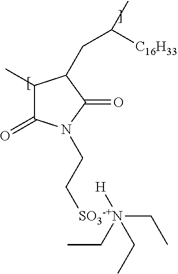

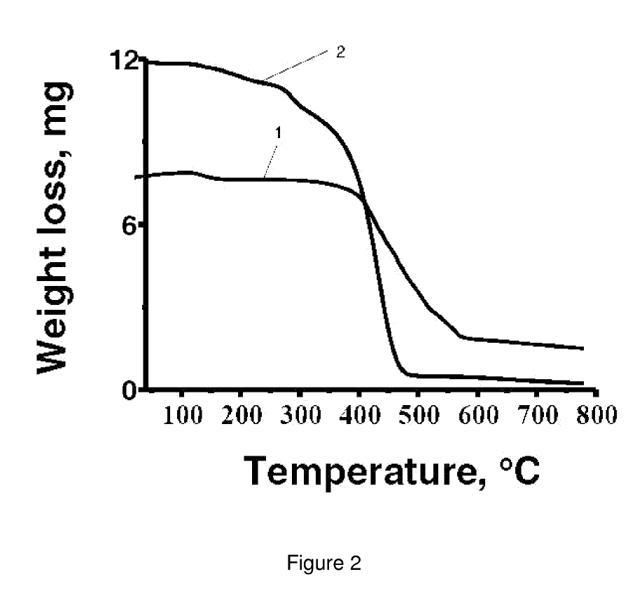

Thermogravimetric analysis (TGA) (Nitrogen atmosphere; heating rate: 10° C./min): 5% weight loss at 298° C., 10% weight loss at 336° C. and 20% weight loss at 358° C. The weight loss curve (1) is shown in FIG. 2, and shows weight loss in mg (Y axis) obtained directly from the TGA instrument.

The contribution of triethyl amine (TEA) to the polymer is 18.1 wt %. Assuming that the TEA is not strongly bound to the polymer, it would be expected to observe a higher weight loss at lower temperatures due to the low boiling point of TEA (bp 88.8° C.). However, this was not observed, indicating that the TEA is strongly bound to the polymer and does not leave the polymer chain until the degradation of the backbone begins to occur. The thermogram that is marked as 2 in FIG. 2 is that of the starting material, viz. poly(maleic an hydride-alt-octadecene).

The contribution of triethyl amine (TEA) in terms of weight % to the polymer can be calculated by using the equation:

$$\begin{matrix}WT \% of TEA = \{ MW of TEA / Repeat unit MW \} \times 100 \\ = \{ 101.19 / 558.86 \} \times 100 \\ = 18.1 .\end{matrix}$$

The boiling point of TEA is 88.8° C. Since the 20% wt loss is observed in the polymer only above 350° C., the polymer in the form of quaternary ammonium salt is very stable. This also implies that the structure of polymer remains intact at high temperatures.

### Preparation of Polymer Solution in Water to Make Clear Coat

The quaternary ammonium salt of sulfonic acid group containing polymer (100 mg) of Example 1 was added to a sample bottle containing water (10 mL). The sample was allowed to dissolve overnight.

A colourless solution was obtained. The pH of the solution was between 6 and 7. A rectangular glass plate was covered with the polymer solution by dropwise addition and the water was allowed to evaporate under ambient conditions. After 18 h, the glass plate was covered with a homogenous, transparent film which was free of cracks.

### Adhesive to Bond Glass Plates

A rectangular glass plate was covered with the above mentioned aqueous solution. Another glass plate of the same size was placed on top of the aqueous solution and the two slides separated by the layer of aqueous solution were left in a fume hood overnight under ambient conditions. The glass plates were bonded together strongly and also showed birefringence. Indeed, the birefringent nature was found to be concentration dependent. Glass plates bonded together with a 1 wt % solution showed birefringence and those bonded together by a 5 wt % solution did not show birefringence. In both cases the adhesive layer was transparent.

### Preparation of Transparent Film

The quaternary ammonium salt of sulfonic acid group containing polymer (100 mg) of Example 1 was added to a sample bottle containing chloroform (1 mL). The polymer was allowed to dissolve completely and form a clear solution. The top portion of a rectangular glass plate was then covered with this solution by dropwise addition and placed in a fume hood. After 24 h, the glass plate was immersed in a 100 ml beaker containing 80 mL of hexane. A flexible, transparent, free standing, thin film was separated from the glass plate which was then dried under ambient conditions.

The flexibility of the film was tested by a simple manual bending test and it was found that the free standing film could be bent to 180°.

Equilibrium swelling ratio in 0.9 wt % NaCl solution=55% {Swelling ratio=([Weight of swollen polymer−weight of dry polymer]/weight of dry polymer)×100}

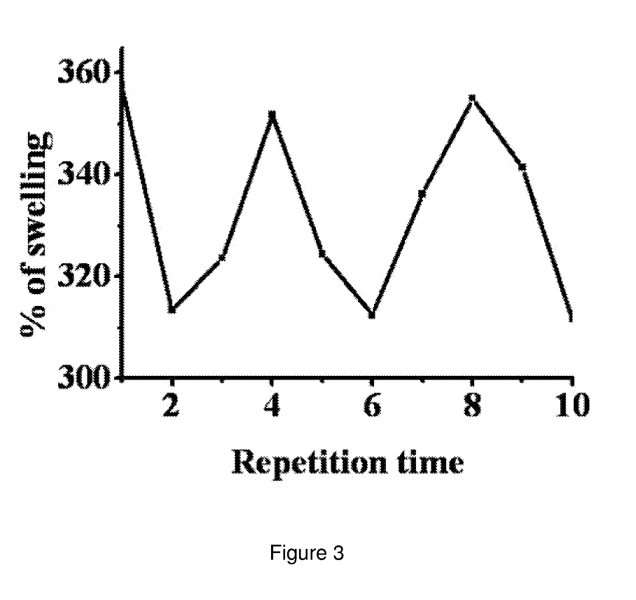

The reversibility of swelling in deionized water is shown in FIG. 3. For each repetition, the polymer was allowed to reach equilibrium swelling and then dried at 80° C. for 24 hours. Ten repetitions were made. No adverse change in swelling tendency was observed. This shows that the polymer has a robust structure that can tolerate repeated swelling and drying without loss of performance.

### Example 2

### Preparation of Quaternary Ammonium Salt of Sulfonic Acid Group Containing Polymer Partly Grafted with Ethanol Amine

To an oven dried single neck round bottom flask, poly(maleic anhydride-altoctadecene) (3.5 g), and taurine (0.63 g) were added. These two solids were stirred slowly using a magnetic stirrer. Dry N,N-dimethylformamide (DMF) (30 mL) was added through a syringe and the stirrer speed was increased. Triethylamine (0.5 g, 0.7 mL) was then added. The suspension turned light brown immediately after the addition of tertiary amine. The flask was then fitted with a double surface condenser and a drying tube on top of the condenser. This reaction mixture was heated slowly in an oil bath. At about 90° C., a clear solution was obtained. Ethanol amine (0.31 g, 0.3 mL) was added and flask was heated to reflux for 18 h.

The reaction flask was then cooled and the DMF solution was added dropwise to a beaker containing a large excess of water. The swollen gel was separated by filtration, washed repeatedly with water. It was then transferred to a beaker and dried.

Yield 4 g. Gel Permeation Chromatography (Polystyrene standard; THF eluent): Mn=17783; Mw=30194; Polydispersity=1.7.

IR (KBr) cm⁻¹: 3434, 2923, 1771, 1699, 1444, 1402, 1342, 1210, 1176, 1041, 750.

¹H-NMR (CDCl₃) δ (ppm): 0.6-0.7 (t), 0.95-1.1 (b), 1.1-1.2 (t), 2.5-2.6 (b), 2.85-3.0 (b), 3.3-3.65 (b), 9.2-9.5 (b). ¹³C-NMR (CDCl₃) δ (ppm): 8.71, 14.13, 22.69, 27.72, 29.38, 29.77, 31.93, 35.57, 46.28, 59, 179.

Thermogravimetric analysis (TGA) (Nitrogen atmosphere; heating rate: 10° C./min): 5% weight loss at 298° C., 10% weight loss at 336° C. and 20% weight loss at 358° C.

### Preparation of Water Based Gel

The polymer obtained in example 2 (0.5 g) was added to a sample bottle containing water (5 mL). The polymer was allowed to disperse in water overnight. A stable, colourless, translucent gel was formed.

### Example 3

### Preparation of Quaternary Ammonium Salt of Sulfonic Acid Group Containing Polymer Partly Grafted with Hexyl Amine

To an oven dried single neck round bottom flask, poly(maleic anhydride-altoctadecene) (3.5 g), and taurine (0.63 g) were added. These two solids were stirred slowly using a magnetic stirrer. Dry N,N-dimethylformamide (DMF) (30 mL) was added through a syringe and the stirrer speed was increased. Triethylamine (0.5 g, 0.7 mL) was then added. The suspension turned light brown immediately after the addition of tertiary amine. The flask was then fitted with a double surface condenser and a drying tube on top of the condenser. This reaction mixture was heated slowly in an oil bath. At about 90° C., a clear solution was obtained. Hexyl amine (0.51 g, 0.7 mL) was added and flask was heated to reflux for 18 h.

The reaction flask was then cooled and the DMF solution was added dropwise to a beaker containing a large excess of water. The swollen gel was separated by filtration, washed repeatedly with water. It was then transferred to a beaker and dried.

Yield 3.6 g. Gel Permeation Chromatography (Polystyrene standard; THF eluent): Mn=12319; Mw=18649; Polydispersity=1.5.

IR (KBr) cm⁻¹: 3469, 2924, 2853, 1771, 1696, 1467, 1403, 1347, 1208, 1177, 1041, 749.

¹H-NMR (CDCl₃) δ (ppm): 0.61-0.65 (t), 0.9-1.1 (b), 1.09-1.13 (t), 2.5-2.6 (b), 2.912.94 (b), 3.15-3.25 (b), 3.7-3.8 (b), 9.7-9.8 (b). ¹³C-NMR (CDCl₃) δ (ppm): 8.68, 14.02, 14.12, 22.54, 22.69, 26.58, 27.66, 28.94, 29.15, 29.38, 29.5, 29.69, 29.77, 31.34, 31.93, 33.82, 35.53, 46.2, 48, 179.

Thermogravimetric analysis (TGA) (Nitrogen atmosphere; heating rate: 10° C./min): 5% weight loss at 289° C., 10% weight loss at 337° C. and 20% weight loss at 363° C.

### Preparation of Water Based Gel

The polymer obtained in example 3 (0.5 g) was added to a sample bottle containing water (5 mL). The polymer was allowed to disperse in water overnight. A stable, colourless, milky white gel was formed.

### Example 4

### Preparation of Quaternary Ammonium Salt of Sulphonic Acid Group Containing Polymer Partly Grafted with Hexyl Amine and Ethanol Amine

To an oven dried single neck round bottom flask, poly(maleic anhydride-altoctadecene) (3.5 g), and taurine (0.63 g) were added. These two solids were stirred slowly using a magnetic stirrer. Dry N,N-dimethylformamide (DMF) (30 mL) was added through a syringe and the stirrer speed was increased. Triethylamine (0.5 g, 0.7 mL) was then added. The suspension turned light brown immediately after the addition of tertiary amine. The flask was then fitted with a double surface condenser and a drying tube on top of the condenser. This reaction mixture was heated slowly in an oil bath. At about 90° C., a clear solution was obtained. Hexyl amine (0.26 g, 0.3 mL) and ethanol amine (0.16 g, 0.16 mL) were added and flask was heated to reflux for 18 h.

The reaction flask was then cooled and the DMF solution was added dropwise to a beaker containing a large excess of water. The swollen gel was separated by filtration, washed repeatedly with water. It was then transferred to a beaker and dried.

Yield 3.8 g. Gel Permeation Chromatography (Polystyrene standard; THF eluent): Mn=13392; Mw=21999; Polydispersity=1.6.

IR (KBr) cm⁻¹: 3445, 2923, 2854, 1771, 1698, 1467, 1403, 1346, 1177, 1042, 750.

¹H-NMR (CDCl₃) δ (ppm): 0.86-0.9 (t), 1.2-1.3 (b), 1.34-1.38 (t), 2.6-2.9 (b), 3.1-3.3 (b), 3.5-3.9 (b), 9.9-10.1 (b). ¹³C-NMR (CDCl₃) δ (ppm): 8.66, 14.02, 14.13, 22.52, 22.7, 26.58, 27.59, 28.94, 29.15, 29.39, 29.51, 29.7, 29.77, 31.33, 31.94, 33.82, 35.54, 46.16.

Thermogravimetric analysis (TGA) (Nitrogen atmosphere; heating rate: 10° C./min): 5% weight loss at 293° C., 10% weight loss at 339° C. and 20% weight loss at 361° C.

### Preparation of Water Based Gel

The polymer obtained in example 4 (0.5 g) was added to a sample bottle containing water (5 mL). The polymer was allowed to disperse in water overnight. A stable, colourless, milky white gel was formed.

### Example 5

### Preparation of Quaternary Ammonium Salt of Sulfonic Acid Group Containing Polymer Partly Crosslinked with Hexamethylene Diamine

To an oven dried single neck round bottom flask, poly(maleic anhydride-altoctadecene) (3.5 g), and taurine (0.63 g) were added. These two solids were stirred slowly using a magnetic stirrer. Dry N,N-dimethylformamide (DMF) (30 mL) was added through a syringe and the stirrer speed was increased. Triethylamine (0.5 g, 0.7 mL) was then added. The suspension turned light brown immediately after the addition of tertiary amine. The flask was then fitted with a double surface condenser and a drying tube on top of the condenser. This reaction mixture was heated slowly in an oil bath. At about 90° C., a clear solution was obtained. Hexamethylene diamine (0.23 g) was added and the flask was heated to reflux for 18 h.

The reaction flask was then cooled and the DMF solution was added dropwise to a beaker containing a large excess of ethyl acetate and stirred well. The solid separated was allowed to settle. The ethylacetate layer was decanted off and the solid residue was washed repeatedly with ethyl acetate. Then the beaker was air dried to constant weight.

Yield 3.8 g. Gel Permeation Chromatography (Polystyrene standard; THF eluent): Mn=18591; Mw=29166; Polydispersity=1.5.

IR (KBr) cm⁻¹: 3445, 2924, 2853, 1772, 1699, 1465, 1403, 1347, 1179, 1041, 749.

¹H-NMR (CDCl₃) δ (ppm): 0.85-0.88 (t), 1.1-1.3 (b), 1.3-1.4 (t), 2.7-2.8 (b), 3-3.1 (b), 3.1-3.3 (b), 3.6-3.8 (b), 9.65-9.8 (b). ¹³C-NMR (CDCl₃) δ (ppm): 8.72, 14.12, 22.69, 29.38, 29.76, 31.93, 34.02, 35.47, 46.28, 179.4.

Thermogravimetric analysis (TGA) (Nitrogen atmosphere; heating rate: 10° C./min): 5% weight loss at 283° C., 10% weight loss at 330° C. and 20% weight loss at 360° C.

### Preparation of Water Based Gel

The polymer obtained in example 5 (0.5 g) was added to a sample bottle containing water (5 mL). The polymer was allowed to disperse in water overnight. A stable, colourless, translucent gel was formed.

Equilibrium swelling ratio in deionized water=357%

Equilibrium swelling ratio in 0.9 wt % NaCl solution=37%.

### Example 6

### Paint Composition

The polymer of Example 1 was added to a paint composition and the contact angle of the exterior surface of the resulting paint composition (when dried) was measured (with water by a static method using a goniometer). The paint composition containing the polymer additive had a contact angle of 65.03°. A similar measurement made using an identical paint composition, except for the absence of the polymer, had a contact angle of 77°. Thus, the polymer lowered significantly the contact angle. Furthermore, the polymer was fully compatible with the paint composition, as indicated by the smoothness of the finished coating. The paint composition was an exterior wall coating made up of water based emulsion containing latex and inorganic particles.

### Comparative Example 1

Poly(maleic anhydride-alt-octadecene) (the starting material for Example 1) was dispersed in aqueous alkali solution at 10 wt % concentration and cast onto a glass plate. A similar test was done using poly(maleic an hydride-alt-octadecene) with chloroform as solvent. In both cases no film formation was observed.

### Comparative Example 2

An alkali salt of poly(maleic anhydride-alt-octadecene), which is the starting material for example 1, was prepared and added to water. The resultant solution was opaque and inhomogeneous with the visible settling down of polymer.

### Comparative Example 3

Poly(vinyl alcohol) was added to water. The resultant solution was opaque and inhomogeneous with the visible settling down of swollen polymer.

### Comparative Example 4

Poly(vinyl alcohol) was added to water. The resultant solution was applied to a rectangular glass slide. Another glass plate of the same size was placed on top of the layer of aqueous solution and left in a fume hood overnight under ambient conditions. The glass plates were bonded together in a non-transparent manner and dispersed particles were observed throughout the bonded surface indicating the formation of inhomogeneous adhesive layer.

To further illustrate certain aspects of the invention, the following embodiments are disclosed with particularity:

1. A polymer having repeating units comprising a cyclic imido sulfonic acid according to formula I

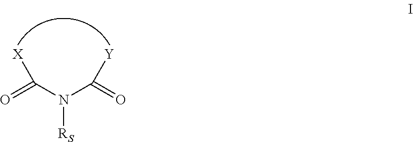

wherein X and Y are selected to form an optionally substituted cyclic imido; and R_{S} is a sulfonic acid-containing group or salt thereof.
2. A polymer according to embodiment 1, wherein the cyclic imido sulfonic acid according to formula I is the reaction product of a poly(cyclic anhydride) and an amino sulfonic acid.
3. A polymer according to embodiment 2, wherein the cyclic anhydride is selected from alicyclic and aromatic anhydrides.
4. A polymer according to embodiment 3, wherein the cyclic anhydride is maleic anhydride.
5. A polymer according to any one of embodiments 2 to 4, wherein the amino sulfonic acid is NH₂—R₁—SO₃H, wherein R₁ is selected from optionally substituted C₁ to C₁₀ alkylene and C₅ to C₂₀ arylene.
6. A polymer according to embodiment 5, wherein the amino sulfonic acid is selected from taurine (2-aminoethanesulfonic acid) and metanilic acid (3-aminobenzenesulfonic acid).
7. A polymer according to any one of the preceding embodiments, wherein R_{S} is a sulfonic acid salt and the salt is selected from a quaternary ammonium salt and an alkali metal salt.
8. A polymer according to any one of the preceding embodiments, wherein in addition to the units comprising imido sulfonic acid groups according to formula I, the polymer comprises units derived from at least one ethylenically unsaturated monomer.
9. A polymer according to embodiment 8, wherein each of the at least one ethylenically unsaturated monomer is selected independently from alkene (preferably ethylene, propylene, octadecene), styrene, vinyl pyrrolidine and (meth)acrylate(s) (preferably methyl methacrylate), isobutene, vinyl pyridine, acrylonitrile, vinyl chloride and acrylic acid.
10. A polymer according to any one of the preceding embodiments, wherein the polymer comprises
(1) 50 to 100% units according to formula II

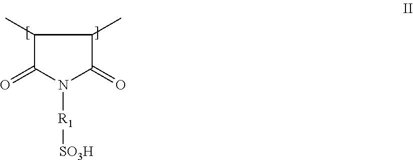

wherein R₁ is selected from optionally substituted C₁ to C₁₀ alkylene and C₅ to C₂₀ arylene, or a salt thereof; and
(2) 0 to 50% units derived from at least one ethylenically unsaturated monomer.
11. A polymer according to embodiment 10, comprising units according to formula III

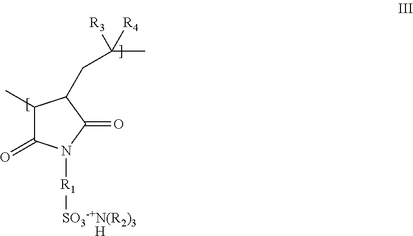

wherein
R₁ is selected from optionally substituted C₁ to C₁₀ alkylene and C₅ to C₂₀ arylene;
each R₂ is selected independently from H and optionally substituted C₁ to C₁₀ alkyl; and
R₃ and R₄ are selected independently from H and optionally substituted C₁ to C₃₀ alkyl, C₅ to C₂₀ aryl, pyrrolidinyl, carboxy and ester.
12. A polymer according to embodiment 11, wherein R₃ and R₄ are selected independently from H and optionally substituted C₁ to C₂₀ alkyl
13. A polymer according to embodiment 12, wherein R₃ and R₄ are selected independently from H and optionally substituted C₁₀ to C₂₀ alkyl
14. A polymer according to embodiment 13, wherein R₃ and R₄ are selected independently from H and optionally substituted C₁₅ to C₁₈ alkyl.
15. A polymer according to embodiment 14, wherein R₃ and R₄ are selected independently from H and optionally substituted C₁₅ to C₁₈ alkyl.
16. A polymer according to embodiment 16, wherein R₃ is H and R₄ is hexadecyl.
17. A polymer according to any one of embodiments 11 to 16, wherein R₁ is selected from optionally substituted C₁ to C₆ alkylene and C₅ to C₁₅ arylene.
18. A polymer according to embodiment 17, wherein R₁ is selected from optionally substituted C₁ to C₄ alkylene and C₅ to C₁₀ arylene.
19. A polymer according to embodiment 18, wherein R₁ is selected from optionally substituted C₂ to C₄ alkylene and C₅ to C₈ arylene.
20. A polymer according to embodiment 19, wherein R₁ is selected from ethylene and phenylene.
21. A polymer according to any one of embodiments 11 to 20, wherein each R₂ is selected independently from H and optionally substituted C₁ to C₁₀ alkyl.
22. A polymer according to embodiment 21, wherein each R₂ is selected independently from H and optionally substituted C₁ to C₆ alkyl.
23. A polymer according to embodiment 22, wherein each R₂ is selected independently from H and optionally substituted C₁ to C₃ alkyl.
24. A polymer according to embodiment 23, wherein each R₂ is selected independently from H and ethyl.
25. A polymer according to embodiment 24, wherein each R₂ is ethyl.
26. A polymer according to any one of embodiments 11 to 25, wherein in addition to units according to formula III, the polymer also comprises units according to formula IV

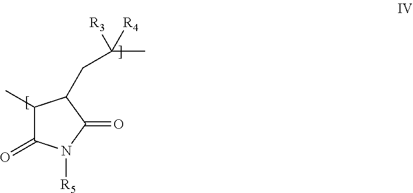

wherein R₅ is selected from optionally substituted C₁ to C₁₀ alkyl and C₅ to C₂₀ aryl; and
R₃ and R₄ are as defined in any one of embodiments 2 to 16.
27. A polymer according to embodiment 26, wherein R₅ is selected from optionally substituted C₂ to C₈ alkyl.
28. A polymer according to embodiment 27, wherein R₅ is selected from amine and hydroxyl substituted C₂ to C₈ alkyl.
29. A polymer according to embodiment 28, wherein R₅ is C₆ alkyl.
30. A polymer according to embodiment 29, wherein R₅ is selected from hexyl and hexamethylamine.
31. A polymer according to embodiment 30, wherein R₅ is optionally substituted C₂ alkyl.
32. A polymer according to embodiment 31, wherein R₅ is ethylalcohol.
33. A polymer according to embodiment 26, wherein R₅ is selected from hexyl, hexamethylamine and ethylalcohol.
34. A polymer according to any one of embodiments 11 to 33, wherein the polymer comprises units according to formulae III, IV and V

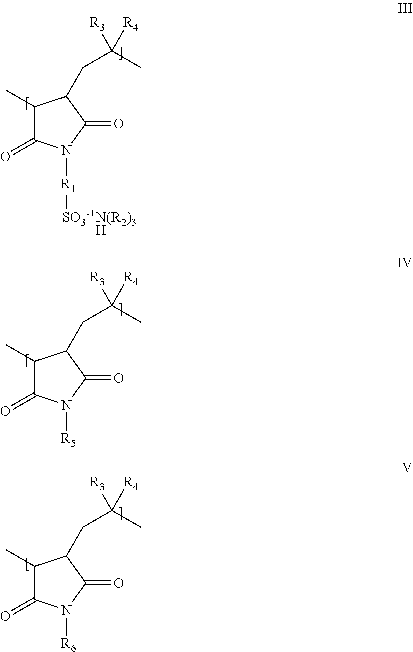

wherein
R₁ is as defined in any one of the preceding embodiments;
each R₃ and R₄ is independently as defined in any one of the preceding embodiments; and
R₅ and R₆ are selected independently from the definitions of R₅ in any one of embodiments 26 to 33.
35. A polymer according to embodiment 34, wherein R₅ and R₆ are different.
36. A polymer according to embodiment 34 or embodiment 35, wherein the units according to formula III are present, as a % of all of the units, in an amount of at least 50%.
37. A polymer according to any one of embodiments 34 to 36, wherein the ratio of units of formula III to the total number of units of formulae IV and V is at least 1.
38. A polymer according to embodiment 37, wherein the ratio is at least 5.
39. A polymer according to embodiment 38, wherein the ratio is at least 10.
40. A polymer according to any one of embodiments 34 to 39, wherein the polymer consists essentially of units according to formulae III, IV and V.
41. A polymer according to any one of the preceding embodiments, wherein the polymer is crosslinked.
42. A polymer according to embodiment 41, wherein the polymer comprises crosslinking groups according to formula VI

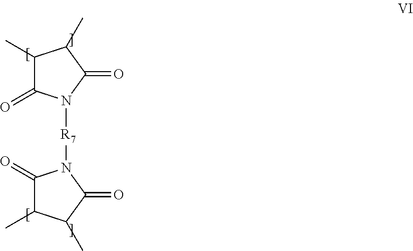

wherein R₇ is selected from optionally substituted C₁ to C₁₀ alkylene and C₅ to C₂₀ arylene.
43. A polymer according to embodiment 41 or embodiment 42, wherein the degree of crosslinking is no more than 50%.
44. A polymer according to any one of the preceding embodiments, wherein the molecular weight of the polymer is in the range of 1000 to 1,000,000.
45. A polymer according to embodiment 44, wherein the molecular weight of the polymer is in the range of 5000 to 50,000.
46. A polymer according to embodiment 45, wherein the molecular weight of the polymer is in the range of 10,000 to 50,000.
47. A method of forming a polymer comprising the step of:

(1) reacting a poly(cyclic anhydride) with an amino sulfonic acid to form poly(imido sulfonic acid).

48. A method according to embodiment 47, wherein the poly(cyclic anhydride) is a co-polymer comprising units derived from (i) maleic anhydride and (ii) at least one ethylenically unsaturated monomer.
49. A method according to embodiment 48, wherein the co-polymer is selected from poly(maleic anhydride-alt-octadecene), poly(maleic anhydride-alt-α-olefin), poly(maleic anhydride-alt-1-tetradecene) and poly(maleic an hydride-alt-isobutene).
50. A method according to any one of embodiments 47 to 49, wherein the amino sulfonic acid is used in a sub-stoichiometric amount such that not all of the cyclic anhydride is converted to an imido sulfonic acid in step (1), and the method includes the step of (2) reacting the poly(cyclic anhydride) with a primary amine.
51. A method according to any one of embodiments 47 to 50, wherein the method includes the step of adding a tertiary amine to the reaction product of step (1) or step (2) to form a quaternary ammonium salt
52. A method according to any one of embodiments 47 to 51, wherein the reaction temperature of step (1) is in the range of room temperature to 200° C.
53. A method according to embodiment 52, wherein the reaction temperature of step (1) is in the range 60° to 180° C.
54. A method according to any one of embodiments 47 to 53, wherein the reaction occurs in a dipolar aprotic solvent.
55. A method according to any one of embodiments 47 to 54, wherein the reaction occurs in a high boiling point polar solvent.
56. A method according to embodiment 54 or embodiment 55, wherein the solvent is selected from N,N-dimethyl formamide, N,N-dimethyl acetamide and N-methylpyrrolidone.
57. A polymer formed by the method of any one of embodiments 47 to 56.
58. A latex comprising a polymer according to any one of embodiments 1 to 46 and 57.
59. A paint composition comprising a polymer according to any one of embodiments 1 to 46 and 57.
60. An adhesive comprising a polymer according to any one of embodiments 1 to 46 and 57.
61. A surfactant composition comprising a polymer according to any one of embodiments 1 to 46 and 57.
62. A surfactant composition according to embodiment 61, wherein the surfactant is a liquid.
63. A surfactant composition according to embodiment 61, wherein the surfactant is a solid.
64. A method of making a polymer latex, the method comprising the step of dispersing the polymer of any one of embodiments 1 to 46 and 57 in water.
65. A method of preparing a paint composition, the method comprising the step of mixing the polymer of any one of embodiments 1 to 46 and 57 with water.
66. A method according to any one of embodiments 1 to 46 and 57, wherein the method includes the step of adding a pigment.
67. A method of preparing an adhesive, the method comprising the step of adding the polymer of any one of embodiments 1 to 46 and 57 to water.
68. A method of preparing a surfactant composition, the method comprising the step of adding a polymer according to any one of embodiments 1 to 46 and 57 to the composition.
69. Use of a polymer according to any one of embodiments 1 to 46 and 57 in a latex.
70. Use of a polymer according to any one of embodiments 1 to 46 and 57 in a paint composition.
71. Use of a polymer according to any one of embodiments 1 to 46 and 57 in a surfactant composition.

While the invention has been illustrated and described in detail in the drawings and foregoing description, the same are to be considered as illustrative and not restrictive in character, it being understood that only the certain preferred embodiments have been shown and described, and that all changes and modifications that come within the spirit of the invention are desired to be protected.

What is claimed is:

1. A polymer having repeating units comprising a cyclic imido sulfonic acid salt according to formula I 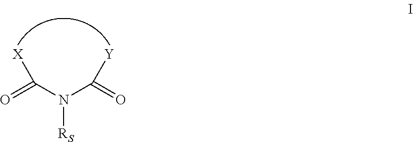
wherein X and Y are selected to form an optionally substituted cyclic imido; and R_{S} is a quaternary ammonium salt of a sulfonic acid-containing group.

2. A polymer according to claim 1, wherein the cyclic imido sulfonic acid salt according to formula I is the reaction product of a poly(cyclic anhydride) and an amino sulfonic acid.

3. A polymer according to claim 2, wherein the cyclic anhydride is selected from alicyclic and aromatic anhydrides.

4. A polymer according to claim 3, wherein the cyclic anhydride is maleic anhydride.

5. A polymer according to claim 2, wherein the amino sulfonic acid is NH₂—R₁—SO₃H, wherein R₁ is selected from optionally substituted C₁ to C₁₀ alkylene and C₅ to C₂₀ arylene.

6. A polymer according to claim 5, wherein the amino sulfonic acid is selected from taurine (2-aminoethanesulfonic acid) and metanilic acid (3-aminobenzenesulfonic acid).

7. A polymer according to claim 1, wherein in addition to the units comprising imido sulfonic acid salt groups according to formula I, the polymer comprises units derived from at least one ethylenically unsaturated monomer.

8. A polymer according to claim 7, wherein each of the at least one ethylenically unsaturated monomer is selected independently from alkene (preferably ethylene, propylene, octadecene), styrene, vinyl pyrrolidine and (meth)acrylate(s) (preferably methyl methacrylate), isobutene, vinyl pyridine, acrylonitrile, vinyl chloride and acrylic acid.

9. A polymer according to claim 1, wherein the polymer comprises
(1) 50 to 100% units of a quaternary ammonium salt of formula II 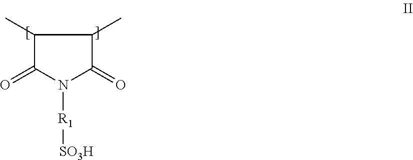
wherein R₁ is selected from optionally substituted C₁ to C₁₀ alkylene and C₅ to C₂₀ arylene; and
(2) 0 to 50% units derived from at least one ethylenically unsaturated monomer.

10. A polymer according to claim 9, comprising units according to formula III 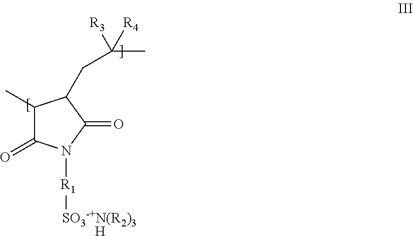
wherein
R₁ is selected from optionally substituted C₁ to C₁₀ alkylene and C₅ to C₂₀ arylene;
each R₂ is selected independently from optionally substituted C₁ to C₁₀ alkyl; and
R₃ and R₄ are selected independently from H and optionally substituted C₁ to C₃₀ alkyl, C₅ to C₂₀ aryl, pyrrolidinyl, carboxy and ester.

11. A polymer according to claim 10, wherein R₃ and R₄ are selected independently from H and optionally substituted C₁₅ to C₁₈ alkyl.

12. A polymer according to claim 10, wherein R₁ is selected from optionally substituted C₂ to C₄ alkylene and C₅ to C₈ arylene.

13. A polymer according to claim 10, wherein each R₂ is selected independently from H and optionally substituted C₁ to C₃ alkyl.

14. A polymer according to claim 10, wherein in addition to units according to formula III, the polymer also comprises units according to formula IV 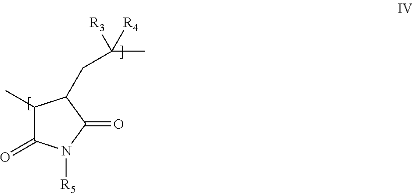
wherein R₅ is selected from optionally substituted C₁ to C₁₀ alkyl and C₅ to C₂₀ aryl; and
R₃ and R₄ are as defined in claim 10.

15. A polymer according to claim 14, wherein R₅ is selected from amine and hydroxyl substituted C₂ to C₈ alkyl.

16. A polymer according to claim 15, wherein R₅ is selected from hexyl, hexamethylamine and ethylalcohol.

17. A polymer according to claim 10, wherein the polymer comprises units according to formulae III, IV and V 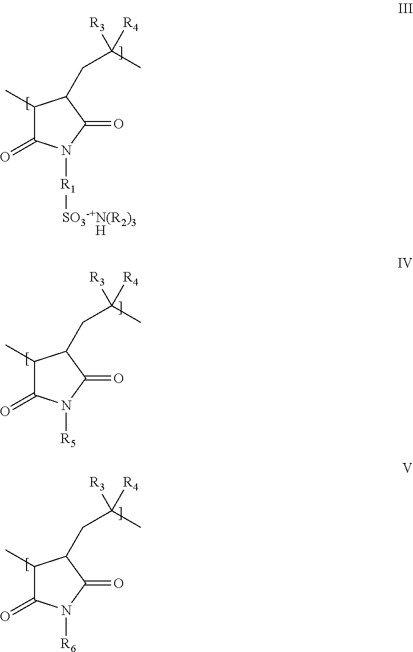
wherein
R₁ is as defined in claim 10;
each R₃ and R₄ is independently as defined in claim 10; and
R₅ and R₆ are selected independently from the definitions of R₅ in claim 14.

18. A polymer according to claim 17, wherein R₅ and R₆ are different.

19. A polymer according to claim 17, wherein the units according to formula III are present, as a % of all of the units, in an amount of at least 50%.

20. A polymer according to claim 17, wherein the ratio of units of formula III to the total number of units of formulae IV and V is at least 5.

21. A polymer according to claim 17, wherein the polymer consists essentially of units according to formulae III, IV and V.

22. A polymer according to claim 1, wherein the polymer is crosslinked.

23. A polymer according to claim 22, wherein the polymer comprises crosslinking groups according to formula VI 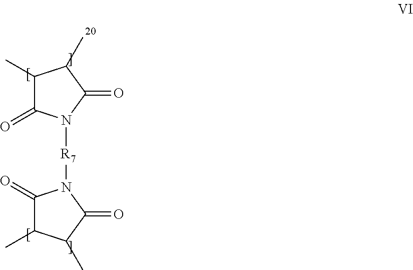
wherein R₇ is selected from optionally substituted C₁ to C₁₀ alkylene and C₅ to C₂₀ arylene.

24. A polymer according to claim 22, wherein the degree of crosslinking is no more than 50%.

25. A polymer according to claim 1, wherein the molecular weight of the polymer is in the range of 10,000 to 50,000.

26. A method of forming a polymer comprising the step of:
(1) reacting a poly(cyclic anhydride) with an amino sulfonic acid to form poly(imido sulfonic acid),
and further including the step of adding a tertiary amine to the reaction to form a quaternary ammonium salt.

27. A method according to claim 26, wherein the poly(cyclic anhydride) is a co-polymer comprising units derived from (i) maleic anhydride and (ii) at least one ethylenically unsaturated monomer.

28. A method according to claim 27, wherein the co-polymer is selected from poly(maleic anhydride-alt-octadecene), poly(maleic anhydride-alt-α-olefin), poly(maleic anhydride-alt-1-tetradecene) and poly(maleic anhydride-alt-isobutene).

29. A method according to claim 26, wherein the amino sulfonic acid is used in a sub-stoichiometric amount such that not all of the cyclic anhydride is converted to an imido sulfonic acid in step (1), and the method includes the step of (2) reacting the poly(cyclic anhydride) with a primary amine.

30. A method according to claim 26, wherein the tertiary amine is added to the reaction product of step (1) or step (2) to form the quaternary ammonium salt.

31. A method according to claim 26, wherein the reaction temperature of step (1) is in the range 60° to 180° C. and wherein the reaction occurs in a dipolar aprotic solvent.

32. A method according to claim 31, wherein the solvent is selected from N,N-dimethyl formamide, N,N-dimethyl acetamide and N-methylpyrrolidone.

33. A polymer formed by the method of claim 26.

34. A latex comprising a polymer according to claim 1.

35. A paint composition comprising a polymer according to claim 1.

36. An adhesive comprising a polymer according to claim 1.

37. A surfactant composition comprising a polymer according to claim 1.
